(19) United States
(12) Patent Application Publication
(10) Pub. No.: US 2008/0311502 A1
(43) Pub. Date: Dec. 18, 2008

(54) Toner For Development of Electrostatic Image

(75) Inventor: Genichi Ota, Tokyo (JP)

Correspondence Address: KRATZ, QUINTOS & HANSON, LLP, 1420 K Street, N.W., Suite 400, WASHINGTON, DC, 20005, US

(73) Assignee: ZEON CORPORATION, TOKYO (JP)

(21) Appl. No.: 11/659,093

(22) PCT Filed: Aug. 4, 2004
(86) PCT No.: PCT/JP04/11511

§ 371 Date: Feb. 1, 2007

(51) Int. Cl. G03G 9/09; G03G 9/08; G03G 9/087

(52) U.S. Cl. 430/108.4; 430/110.3; 430/108.1; 430/109.3

(57) ABSTRACT

A toner for development of electrostatic images, comprising colored particles and an external additive, wherein the colored particles has a volume average particle diameter of 3 to 10 μm and an average circularity of 0.950 to 0.995, and in a molecular weight distribution of THF-soluble matter, which is obtained by filtering a dispersion liquid prepared by stirring the toner in THF, by GPC measurement, a peak area a of a molecular weight range of 500,000 to 5,000,000 is 5 to 15% based on the peak area of the whole range, a peak area b of a molecular weight range of 500,000 to 5,000,000 of tetrahydrofuran-soluble matter, which is obtained by filtering a dispersion liquid prepared by further subjecting the above dispersion liquid to an ultrasonic treatment, is 1 to 10% based on the peak area of the whole range, and the peak area a and the peak area b satisfy the relationship of 0≦a−b≦5.

### TECHNICAL FIELD

The present invention relates to a toner for development of an electrostatic latent image formed by an electrophotographic process (including electrostatic recording process), and particularly to a toner for development of electrostatic images, comprising colored particles and an external additive.

### BACKGROUND ART

Image formation by an electrophotographic process is conducted by a process comprising developing an electrostatic image formed on a photosensitive member with a developer (may referred to as “toner” merely) to form a visible image (i.e., “a toner image”), transferring the toner image to a transfer material such as paper or OHP sheet as needed, and then fixing the toner image to the transfer material.

The developer generally contains, as a functional component, colored particles comprising a binder resin and a colorant. Developers are roughly divided into two-component developers composed of colored particles and carrier particles and one-component developers substantially composed of colored particles alone. The one-component are generally composed of colored particles and an external additive. The external additive has roles of improving the flowability of the colored particles by causing it to adhere to the surfaces of the colored particles and imparting abrasiveness to the colored particles to prevent occurrence of a toner filming phenomenon on a photosensitive member. As the external additive, are used inorganic particles or organic particles having an average particle diameter smaller than that of the colored particles. The external additive may also be added to colored particles used in the two-component developer. a mixture of the colored particles and the external additive is referred to as a toner for development of electrostatic images.

In the image formation by the electrophotographic process, a step, of which great energy is required, is a step of fixing a toner image to a transfer material. As a fixing method, a fixing method by a heated roll is adopted in many image forming apparatus in that energy efficiency is high, and it can meet speeding up. In the fixing method by the heated roll, a transfer material is passed through between a fixing roll heated and a pressure roll to fix the toner image to the transfer material by heating and pressurization.

However, the fixing method by the heated roll tends to cause an offset phenomenon that a part of the toner adheres to the surface of the fixing roll to contaminate an image next formed, since the fixing roll comes into direct contact with the toner image melted by heating under pressure. In order to prevent offset, it is adopted to coat the surface of the fixing roll with silicone rubber or a fluororesin having good releasability and further supply a releasing liquid such as silicone oil to the surface thereof. This method is an effective means for preventing the offset phenomenon of the toner. However, a device for supplying the releasing liquid is separately required, and so the method goes against the trend of weight saving and miniaturization of image forming apparatus in recent years.

It is thus investigated to prevent the offset phenomenon without using the releasing liquid. In recent years, there have been strong demands for reducing running cost and speeding up printing or copying. In order to meet these demands, toners are required to have a high function. In particular, it is desired to develop a toner that can prevent the occurrence of offset and permits fixing at a low temperature.

In order to solve these problems, it is investigated to improve a binder resin of a toner. For example, Japanese Patent Application Laid-Open No. 3-39971 has proposed a color toner comprising a resin component and a colorant, in which the resin component does substantially not contain toluene-insoluble matter and has a peak within a molecular weight range of 500 to 2,000 in a chromatogram by gel permeation chromatography (GPC) of the tetrahydrofuran (THF)-soluble matter of the resin component, the weight average molecular weight (Mw) thereof is 10,000 to 80,000, the number average molecular weight (Mn) thereof 1,500 to 8,000, and a ratio of Mw/Mn is at least 3. However, this color toner involves a problem that when it is applied to a high-speed image forming apparatus, hot offset is easy to occur.

Japanese Patent Application Laid-Open No. 10-333359 discloses a toner for development of electrostatic images comprising at least a binder resin, a colorant and a parting agent, in which the toner has at least one peak in a range of from 1,000 to lower than 2,000 and at least one peak in a range of 2,000 to 300,000 in a molecular weight distribution of the toner by GPC, and a weight average molecular weight (Mw) of 90,000 to 2,000,000, and a molecular weight-integrated value (T) within a molecular weight range of 800 or higher, a molecular weight-integrated value (L) within a molecular weight range of 2,000 to 5,000 and a molecular weight-integrated value (H) within a molecular weight range of 300,000 or higher satisfy a specific relationship. However, this toner involves a problem that it is easy to aggregate under a high-temperature environment to which image forming apparatus is liable to be exposed.

Japanese Patent Application Laid-Open No. 2001-201887 discloses a toner for development of electrostatic images comprising at least a binder resin, a colorant and wax, in which a proportion {W(5×10⁵)} of 5×10⁵ or higher in an integral molecular weight distribution relating to a molecular weight of a THF-soluble component of the toner by GPC is 1% by weight or lower, a proportion {W(3×10³)} of 3×10³ or lower is 30% by weight or lower, and a ratio {W(3×10³)}/{W(5×10⁵)} is 15 to 50. However, when the toner disclosed in this document is used to conduct printing over a long period of time by means of an image forming apparatus of a non-magnetic one-component development system, the toner is broken to cause a filming phenomenon or lower durability.

Japanese Patent Application Laid-Open No. 2003-122050 disclose a toner for development of electrostatic images comprising a resin and a colorant, in which the resin contains a polymerization component of a polymerizable monomer having polar group in a proportion of 1.0 to 10% by mass, a proportion (A/B) of an area A of a chromatographic curve in a molecular weight range of 60,000 to 1,000,000 from a GPC measurement of a THF-soluble component of the toner to an area B of the whole chromatographic curve is 0.5 to 20%, and a peak or shoulder is present in a molecular weight range of 5,000 to 20,000. However, this toner involves a problem that it is easy to aggregate under a high-temperature environment.

### DISCLOSURE OF THE INVENTION

It is an object of the present invention to provide a toner for development of electrostatic images, which is excellent in offset resistance, storage stability under a high-temperature and durability and permits fixing at a low temperature.

The present inventors have carried out an extensive investigation with a view toward achieving the above object. As a result, it has been found that the object can be achieved by a toner for development of electrostatic images, which comprises at least colored particles containing a binder resin and a colorant, and an external additive, in which the colored particles have a volume average particle diameter as small as 3 to 10 μm and are substantially spherical at demonstrated by the average circularity of the colored particles of 0.950 to 0.995, and in a molecular weight distribution of the THF-soluble matter of the toner by GPC measurement, a ratio of a peak area of a specific molecular weight range to the peak area of the whole range is varied within a fixed range by an ultrasonic treatment. The toner according to the present invention is considered to vary its structure such as entanglement of molecular chains by the ultrasonic treatment within a fixed range.

According to the present invention, there is thus provided a toner for development of electrostatic images, comprising colored particles containing at least a binder resin and a colorant, and an external additive, wherein

(a) the colored particles has a volume average particle diameter of 3 to 10 μm and an average circularity of 0.950 to 0.995,

(b) in a molecular weight distribution of the tetrahydrofuran-soluble matter A of the toner, which is obtained by filtering a dispersion liquid D1 prepared by adding 49.9 g of tetrahydrofuran to 0.1 g of the toner and stirring the resultant mixture for 1 hour at 23° C. through a filter having a pore size of 0.2 μm, by gel permeation chromatography (GPC) measurement, a peak area a of a molecular weight range of 500,000 to 5,000,000 in the whole molecular weight range of 500 to 5,000,000 is 5 to 15% based on the peak area of the whole range,

(c) in a molecular weight distribution of the tetrahydrofuran-soluble matter B of the toner, which is obtained by filtering a dispersion liquid D2 prepared by further subjecting the dispersion liquid D1 to an ultrasonic treatment for 10 minutes at output power of 20 W and a frequency of 20 kHz through a filter having a pore size of 0.2 μm, by GPC measurement, a peak area b of a molecular weight range of 500,000 to 5,000,000 in the whole molecular weight range of 500 to 5,000,000 is 1 to 10% based on the peak area of the whole range, and

(d) the peak area a and the peak area b satisfy the relationship of 0≦a−b≦5.

The peak area a and the peak area b may more preferably satisfy a relationship of 1≦a−b≦5.

### BEST MODE FOR CARRYING OUT THE INVENTION

The toner for development of electrostatic images according to the present invention comprises colored particles and an external additive. The toner for development of electrostatic images according to the present invention is preferably a non-magnetic one-component developer or magnetic one-component developer, more preferably a non-magnetic one-component developer.

The colored particles contain at least a binder resin and a colorant and optionally contain a parting agent, a charge control agent and other additives. The colored particles preferably contain a parting agent and a charge control agent. The parting agent is preferably a polyfunctional ester compound. The charge control agent is preferably a charge control resin. The colored particles may contain magnetic powder as the colorant or together with another colorant.

As specific examples of the binder resin, may be mentioned binder resins widely used in toners in the past, such as polystyrene, styrene-butyl acrylate copolymers, polyester resins, epoxy resins and cyclized isoprene rubber.

The number average molecular weight (Mn) of the binder resin is generally 5,000 to 50,000, preferably 7,000 to 30,000. The weight average molecular weight (Mw) of the binder resin is generally 50,000 to 1,000,000, preferably 80,000 to 500,000. The molecular weight distribution (Mw/Mn) of the binder resin is generally 3 to 30, preferably 5 to 20. The number average molecular weight (Mn) and weight average molecular weight (Mw) of the binder resin can be measured as values in terms of standard polystyrene by GPC.

As the colorant, may be used any of various kinds of pigments and dyes used in the field of toners, such as carbon black and titanium white. As examples of black colorants, may be mentioned dyes and pigments such as carbon black and Nigrosine Base; and magnetic powders such as cobalt, nickel, triiron tetroxide, manganese iron oxide, zinc iron oxide and nickel iron oxide. As colorants for color toners, may be used pigments of respective colors such as yellow, magenta and cyan.

As the yellow colorants, may be used fused azo compounds, isoindolinone compounds, anthraquinone compounds, azo metallic complexes, methine compounds and allylamide compounds. Specific examples thereof include C.I. Pigment Yellow 3, 12, 13, 14, 15, 17, 62, 65, 73, 74, 83, 90, 93, 95, 96, 97, 109, 110, 111, 120, 128, 129, 138, 147, 155, 168, 180 and 181. Besides the above, Naphthol Yellow S, Hansa Yellow G and C.I. Vat Yellow are mentioned.

Examples of the magenta colorants include fused azo compounds, diketopyrrolopyrrole compounds, anthraquinone compounds, quinacridone compounds, basic dye lake compounds, naphthol compounds, benzimidazolone compounds, thioindigo compounds and perillene compounds. Specific examples thereof include C.I. Pigment Red 2, 3, 5, 6, 7, 23, 31, 48, 48:2, 48:3, 48:4, 57, 57:1, 58, 60, 63, 64, 68, 81, 81:1, 83, 87, 88, 89, 90, 112, 114, 122, 123, 144, 146, 149, 150, 163, 166, 169, 170, 177, 184, 185, 187, 202, 206, 207, 209, 220, 251 and 254. Besides the above, C.I. Pigment Violet 19 and the like are mentioned.

Examples of the cyan colorants include copper phthalocyanine compounds and derivatives thereof, anthraquinone compounds, and basic dye lake compounds. Specific examples thereof include C.I. Pigment Blue 1, 2, 3, 6, 7, 15, 15:1, 15:2, 15:3, 15:4, 16, 17, 60, 62 and 66. Besides the above, Phthalocyanine Blue, C.I. Vat Blue, C.I. Acid Blue and the like are mentioned.

The amount of the colorant is generally 0.1 to 50 parts by weight, preferably 1 to 20 parts by weight per 100 parts by weight of the binder resin.

Examples of the parting agent include polyolefin waxes such as low molecular weight polyethylene, low molecular weight polypropylene and low molecular weight polybutylene; natural plant waxes such as candelilla, carnauba, rice, Japan wax and jojoba; petroleum waxes such as paraffin, microcrystalline and petrolatum, and modified waxes thereof; synthetic waxes such as Fischer-Tropsch wax; and polyfunctional ester compounds such as pentaerythritol tetramyristate, pentaerythritol tetrapalmitate and dipentaerythritol hexamyristate. These parting agents may be used either singly or in any combination thereof.

Among these parting agents, polyfunctional ester compounds are preferred. Among the polyfunctional ester compounds, polyfunctional ester compounds whose endothermic peak temperatures fall within a range of 30 to 150° C., preferably 40 to 100° C., more preferably 50 to 80° C. upon heating thereof in a DSC curve determined by means of a differential scanning calorimeter (DSC) are preferred because a toner excellent in a balance between the fixing ability and the parting property upon fixing is obtained. Polyfunctional ester compounds having a molecular weight of at least 1,000, a solubility of at least 5 parts by weight in 100 parts by weight of styrene at 25° C. and an acid value of at most 10 mg KOH/g are particularly preferred because they exhibit a marked effect on lowering of a fixing temperature. The endothermic peak temperature is a value measured in accordance with ASTM D 3418-82.

The content of the parting agent is generally 0.5 to 50 parts by weight, preferably 1 to 20 parts by weight per 100 parts by weight of the binder resin.

As the charge control agent, may be used any of charge control agents used in toners in the past. Among the charge control agents, charge control resins are preferred because they are high in compatibility with the binder resin and colorless and can provide a toner stable in charging ability even in continuous color printing at a high speed.

As the charge control resins, are may be used quaternary ammonium (salt) group-containing copolymers prepared in accordance with a process described in, for example, Japanese Patent Application Laid-Open Nos. 63-60458, 3-175456, 3-243954 and 11-15192 and sulfonic (salt) group-containing copolymers prepared in accordance with a process described in, for example, Japanese Patent Application Laid-Open Nos. 1-217464 and 3-15858.

A proportion of a monomer unit having a quaternary ammonium (salt) group or sulfonic (salt) group contained in these charge control resins (copolymers) is generally 0.5 to 15% by weight, preferably 1 to 10% by weight. When the content of the quaternary ammonium (salt) group or sulfonic (salt) group falls within the above-described range, the charge level of the resulting toner is easy to be controlled, and the occurrence of fag can be lessened.

The weight average molecular weight of the charge control resin is within a range of generally 2,000 to 50,000, preferably 4,000 to 40,000, more preferably 6,000 to 30,000. When the weight average molecular weight of the charge control resin falls within the above-described range, the saturation and transparency of the resulting toner can be retained at a good level.

The glass transition temperature of the charge control resin is within a range of generally 40 to 80° C., preferably 45 to 75° C., more preferably 45 to 70° C. When the glass transition temperature of the charge control resin falls within the above-described range, a balance between storage stability and fixing ability in the resulting toner can be improved.

The content of the charge control resin is generally 0.01 to 20 parts by weight, preferably 0.1 to 10 parts by weight per 100 parts by weight of the binder resin.

Examples of the magnetic powder include powders of iron oxides such as magnetite, γ-iron oxide, ferrite and iron-excess ferrite; and metals such as iron, cobalt and nickel, alloys of these metals with aluminum, cobalt, copper, lead, magnesium, tin, zinc, antimony, beryllium, bismuth, cadmium, calcium, manganese, selenium, titanium, tungsten and/or vanadium and mixtures thereof.

The volume average particle diameter dv of the colored particles is generally 3 to 10 μm, preferably 4 to 9 μm, more preferably 5 to 8 μm. If the volume average particle diameter of the colored particles is too small, the flowability of the resulting toner is lowered, and so its transferability may be lowered, blur may occur, or a printing density may be lowered. If the volume average particle diameter of the colored particles is too great, fog and flying-off of the resulting toner occur, and the resolution of an image formed with such a toner is deteriorated.

The particle diameter distribution dv/dp of the colored particles that is represented by a ratio of the volume average particle diameter dv to the number average particle diameter dp is generally 1.0 to 1.3, preferably 1.0 to 1.2. If the particle diameter distribution of the colored particles is too great, the resulting toner tends to causes blur or lower transferability, printing density and resolution.

The volume average particle diameter and particle diameter distribution of the colored particles can be controlled within the above respective ranges by controlling preparation conditions of the colored particles or classifying them.

The average circularity of the colored particles can be measured by means of a Flow Particle Image Analyzer. The average circularity of the colored particles is 0.950 to 0.995, preferably 0.960 to 0.990. If the average circularity of the colored particles is too small, the transferability of the resulting toner is lowered.

In the present invention, the circularity is defined as a value obtained by dividing (the peripheral length of a circle having a projected area equal to a particle image) by (the peripheral length of the projected image of the particle). The average circularity in the present invention is used as a simple and convenient method quantitatively expressing the form of the particles and is an index to the degree of irregularities of the toner. This average circularity indicates 1 where the toner in the form of a complete sphere, and becomes a smaller value as the surface form of the toner particles becomes more complicated. The average circularity Ca is a value determined by the following equation (1).

$$Average circularity = ( {\sum }_{i = 1}^{n} ( Ci \times fi ) ) / {\sum }_{i = 1}^{n} ( fi ) \qquad ( 1 )$$

In the formula (1), n is the number of particles of which the circularity Ci is determined, and fi is a frequency of a particle having a circularity Ci. The circularity Ci is a circularity of each particle calculated out by the following equation (2) on the basis of a peripheral length measured as to each particle in a group of particles corresponding to circles having a diameter of 0.6 to 400 μm.

Circularity Ci=(Peripheral length of a circle equal to the projected area of a particle)/(Peripheral length of the projected image of the particle) (2)

The average circularity can be relatively easily controlled within the above range by, for example, preparing colored particles using a polymerization process such as a suspension polymerization process, phase reversal emulsion process or dissolution suspension process.

The circularity and average circularity can be measured by means of a Flow Particle Image Analyzer “FPIA-2000” or “FPIA-2100” manufactured by SYSMEX CORPORATION.

The colored particles making up the toner for development of electrostatic images according to the present invention may be provided as core-shell type (also referred to as “capsule type”) colored particles obtained by combining 2 different polymers at the interior (core layer) and the exterior (shell layer) of each particle.

Examples of the external additive making up the toner for development of electrostatic images according to the present invention include, inorganic particles, organic resin particles and mixtures thereof. These particles added as the external additive are smaller in average particle diameter than the colored particles.

Examples of the inorganic particles include particles of silica, aluminum oxide, titanium oxide, zinc oxide, tin oxide, barium titanate and strontium titanate. Examples of the organic resin particles include methacrylic ester polymer particles, acrylic ester polymer particles, styrene-methacrylic ester copolymer particles, styrene-acrylic ester copolymer particles, and core-shell type particles in which the core is composed of a styrene polymer, and the shell is composed of a methacrylic ester copolymer. However, the external additive is not limited thereto.

Among these external additives, silica particles and titanium oxide particles are preferred, particles obtained by subjecting the surfaces of these inorganic particles to a hydrophobicity-imparting treatment are more preferred, and silica particles subjected to the hydrophobicity-imparting treatment are particularly preferred.

No particular limitation is imposed on the amount of the external additive used. However, it is generally 0.1 to 6 parts by weight, preferably 0.5 to 3 parts by weight per 100 parts by weight of the colored particles.

In the toner for development of electrostatic images according to the present invention, in a molecular weight distribution of the tetrahydrofuran-soluble matter A of the toner, which is obtained by filtering a dispersion liquid D1 prepared by adding 49.9 g of tetrahydrofuran (THF) to 0.1 g of the toner and stirring the resultant mixture for 1 hour at 23° C. through a filter having a pore size of 0.2 μm, by gel permeation chromatography (GPC) measurement, a peak area a of a molecular weight range of 500,000 to 5,000,000 in the whole molecular weight range of 500 to 5,000,000 is 5 to 15% based on the peak area of the whole range.

More specifically, 49.9 g of THF is added to 0.1 g of the toner containing the colored particles and the external additive, and the resultant mixture is stirred at room temperature (23° C.) for 1 hour to dissolve a soluble component of the toner, thereby preparing the dispersion liquid D1. This dispersion liquid D1 is filtered through the filter having a pore size of 0.2 μm to obtain the THF-soluble matter A of the toner. With respect to this THF-soluble matter A, the peak area a of the molecular weight range of 500,000 to 5,000,000 is 5 to 15%, preferably 6 to 12%, more preferably 7 to 10% based on the peak area of the whole range in the molecular weight distribution (solubility curve; chromatogram) between 500 and 5,000,000 in the molecular weight determined by GPC.

Here, the peak area a means a molecular weight-integrated value within the molecular weight range of 500,000 to 5,000,000 in the molecular weight distribution by GPC. The peak area of the whole range means a molecular weight-integrated value within the molecular weight range (the whole range) of 500 to 5,000,000. If the proportion of the peak area a is too low, the offset resistance of such a toner is lowered to easily cause offset. If the proportion is too high, the fixing temperature of such a toner cannot be sufficiently lowered to deteriorate the low-temperature fixing ability thereof.

In the toner for development of electrostatic images according to the present invention, in a molecular weight distribution of the THF-soluble matter B of the toner, which is obtained by filtering a dispersion liquid D2 prepared by further subjecting the dispersion liquid D1 to an ultrasonic treatment for 10 minutes at output power of 20 W and a frequency of 20 kHz through a filter having a pore size of 0.2 μm, by GPC measurement, a peak area b of a molecular weight range of 500,000 to 5,000,000 in the whole molecular weight range of 500 to 5,000,000 is 1 to 10% based on the peak area of the whole range.

More specifically, 49.9 g of THF is added to 0.1 g of the toner, and the resultant mixture is stirred at room temperature (23° C.) for 1 hour to dissolve the toner, thereby obtaining the dispersion liquid D1. This dispersion liquid D1 is further subjected to the ultrasonic treatment for 10 minutes. A dispersion liquid D2 thus obtained is filtered through the filter having a pore size of 0.2 μm to obtain the THF-soluble matter B of the toner. With respect to this THF-soluble matter B, the peak area b of the molecular weight range of 500,000 to 5,000,000 is 1 to 10%, preferably 2 to 8%, more preferably 3 to 7% based on the peak area of the whole range in the molecular weight distribution in a range (the whole range) of 500 to 5,000,000 in the molecular weight determined by GPC. The peak area b and the peak area of the whole range are both molecular weight-integrated values within the respective molecular weight ranges. If the proportion of the peak area b is too low, the offset resistance of such a toner is lowered to easily cause offset. If the proportion is too high, the low-temperature fixing ability of such a toner is deteriorated.

In the toner for development of electrostatic images according to the present invention, it is necessary for the peak area a and the peak area b to satisfy the relationship of 0≦a−b≦5. In other words, a difference a−b between the peak area a and the peak area b is from 0 to 5. This difference a−b is preferably from 1 to 5 (1≦a−b≦5), more preferably from 1 to 4 (1≦a−b≦4).

If this difference a−b is smaller than 0, the low-temperature fixing ability of such a toner is deteriorated. If the difference is greater than 5 on the other hand, the offset resistance of such a toner is deteriorated. When this difference a−b is 1 or greater, the toner is provided as a toner, in which a proportion of the polymer having a molecular weight within the specific range obtained by the GPC measurement is varied within a fixed range by an ultrasonic treatment. Thus, the difference of 1 or greater is more preferred in that the object of the present invention is achieved.

In the toner for development of electrostatic images according to the present invention, in the molecular weight distribution in a range of 500 to 5,000,000 in the molecular weight of the THF-soluble matter A determined by GPC, a peak area c of a molecular weight range of 500 to 5,000 is preferably 3 to 20%, more preferably 5 to 15% based on the peak area of the whole range. If the proportion of the peak area c is too low, the low-temperature fixing ability of such a toner may be deteriorated in some cases. If the proportion is too high on the other hand, the offset resistance of such a toner may be deteriorated in some cases.

The measuring method for these peak areas is as described in EXAMPLES, which will be described subsequently.

In the toner for development of electrostatic images according to the present invention, the content of volatile organic compounds in the toner is preferably at most 500 ppm, more preferably at most 300 ppm. If the content of the volatile organic compounds is too high, the offset resistance of such a toner may be deteriorated in some cases. In addition, such a toner tends to emit odor upon fixing of the toner. The content of the volatile organic compounds can be measured by a measuring method described in EXAMPLES.

The colored particles used in the present invention can be obtained preferably by the polymerization process. For example, a suspension polymerization process and an emulsion polymerization process are representative of the polymerization process. The colored particles obtained by the polymerization process may be associated as needed for the purpose of adjusting the particle diameter thereof.

Upon the production of the colored particles by the polymerization process, the amount of a crosslinkable monomer used, the amount of a molecular weight modifier (chain transfer agent) used, the kind and amount of a polymerization initiator used and polymerization conditions such as a polymerization temperature are controlled, whereby a toner, which is substantially spherical, can cause additive components (internal additives) such as a parting agent to exist in the interior of each colored particle and satisfies the requirements of the above-described peak areas, can be obtained.

The production process of the colored particles by the suspension polymerization process that is representative of the polymerization process will hereinafter be described.

The colored particles making up the toner according to the present invention can be produced by dispersing a polymerizable monomer composition containing a polymerizable monomer, which will become a binder resin component, a colorant and various kinds of additive components in an aqueous dispersion medium, and heating the resultant aqueous dispersion to a predetermined temperature in the presence of a polymerization initiator to conduct polymerization. After the polymerization, washing and dehydration are conducted in accordance with a method known per se in the art, and drying is conducted to collect colored particles.

As examples of the polymerizable monomer for obtaining the binder resin, may be mentioned a monovinyl monomer, a crosslinkable monomer and a macromonomer. The binder resin is formed by polymerizing the polymerizable monomer. The colorant and other additive components are contained in a dispersed state in the binder resin.

Examples of the monovinyl monomers include aromatic vinyl monomers such as styrene, vinyltoluene and α-methylstyrene; acrylic acid and methacrylic acid; (meth)acrylic monomers such as methyl acrylate, ethyl acrylate, propyl acrylate, butyl acrylate, 2-ethylhexyl acrylate, cyclohexyl acrylate, isobonyl acrylate, dimethylaminoethyl acrylate, acrylamide, methyl methacrylate, ethyl methacrylate, propyl methacrylate, butyl methacrylate, 2-ethylhexyl methacrylate, cyclohexyl methacrylate, isobonyl methacrylate, dimethylaminoethyl methacrylate and methacrylamide; and monoolefin monomers such as ethylene, propylene and butylene.

The monovinyl monomers may be used either singly or in any combination thereof. Among these monovinyl monomers, aromatic vinyl monomers, and combinations of an aromatic vinyl monomer and an (meth)acrylic monomer are preferably used.

When a crosslinkable monomer is used together with the monovinyl monomer, hot offset of the resulting toner can be effectively improved. The crosslinkable monomer is a monomer having at least 2 vinyl groups. Specific examples thereof include aromatic divinyl compounds such as divinylbenzene, divinylnaphthalene and derivatives thereof; diethylenically unsaturated carboxylic esters such as ethylene glycol dimethacrylate and diethylene glycol dimethacrylate; compounds having 2 vinyl groups, such as N,N-divinylaniline and divinyl ether; and compounds having at least 3 vinyl groups, such as pentaerythritol triallyl ether and trimethylolpropane triacrylate. These crosslinkable monomers may be used either singly or in any combination thereof.

The amount of the crosslinkable monomer used is generally at most 2 parts by weight, preferably 0.05 to 1 part by weight, more preferably 0.1 to 0.5 part by weight per 100 parts by weight of the monovinyl monomer.

It is preferable to use a macromonomer together with the monovinyl monomer because a balance between storage stability and low-temperature fixing ability of the resulting toner is improved. The macromonomer is a compound having a polymerizable carbon-carbon unsaturated double bond at its molecular chain terminal and is an oligomer or polymer having a number average molecular weight of generally 1,000 to 30,000. The macromonomer is preferably that giving a polymer having a glass transition temperature higher than that of a polymer obtained by polymerizing the monovinyl monomer.

The amount of the macromonomer used is generally 0.01 to 10 parts by weight, preferably 0.03 to 5 parts by weight, more preferably 0.1 to 1 part by weight per 100 parts by weight of the monovinyl monomer.

Examples of the dispersion stabilizer include inorganic salts such as barium sulfate, calcium sulfate, calcium carbonate, magnesium carbonate and calcium phosphate; inorganic oxides such as aluminum oxide and titanium oxide; inorganic hydroxides such as aluminum hydroxide, magnesium hydroxide and ferric hydroxide; water-soluble polymers such as polyvinyl alcohol, methyl cellulose and gelatin; and surfactants such as anionic surfactants, nonionic surfactants and amphoteric surfactants. These dispersion stabilizers may be used either singly or in any combination thereof.

Among the dispersion stabilizers, dispersion stabilizers containing colloid of an inorganic compound, particularly, a hardly water-soluble metal hydroxide are preferred because the particle diameter distribution of the resulting polymer particles can be narrowed, an amount of the dispersion stabilizer remaining after washing is little, and a toner capable of brightly or sharply reproducing an image can be provided.

The colloid of the hardly water-soluble metal hydroxide is not limited by the production process thereof. However, it is preferable to use colloid of a hardly water-soluble metal hydroxide obtained by adjusting the pH of an aqueous solution of a water-soluble polyvalent metallic compound to 7 or higher, in particular, colloid of a hardly water-soluble metal hydroxide formed by reacting a water-soluble polyvalent metallic compound with an alkali metal hydroxide in a water phase. The colloid of the hardly water-soluble metal hydroxide preferably has number particle diameter distributions, D50 (50% cumulative value of a number particle diameter distribution) of at most 0.5 μm and D90 (90% cumulative value of the number particle diameter distribution) of at most 1 μm.

The dispersion stabilizer is used in a proportion of generally 0.1 to 20 parts by weight per 100 parts by weight of the polymerizable monomer. The dispersion stabilizer is preferably used in the proportion falling within the above-described range because sufficient polymerization stability is achieved, formation of polymer aggregates is inhibited, and a toner having a desired particle diameter can be obtained.

As examples of the polymerization initiator, may be mentioned persulfates such as potassium persulfate and ammonium persulfate; azo compounds such as 4,4′-azobis(4-cyanovaleric acid), 2,2′-azobis(2-methyl-N-(2-hydroxyethyl)propionamide, 2,2′-azobis(2-amidinopropane)dihydrochloride, 2,2′-azobis(2,4-dimethylvaleronitrile) and 2,2′-azobisisobutyronitrile; and peroxides such as di-t-butyl peroxide, dicumyl peroxide, lauroyl peroxide, benzoyl peroxide, t-butyl peroxy-2-ethylhexanoate, t-hexyl peroxy-2-ethylhexanoate, t-butyl peroxypivalate, di-isopropyl peroxydicarbonate, di-t-butyl peroxyisophthalate, 1,1,3,3-tetramethylbutyl peroxy-2-ethylhexanoate and t-butyl peroxyisobutyrate. Redox initiators with these polymerization initiators combined with a reducing agent may also be used.

Among these polymerization initiators, an oil-soluble polymerization initiator soluble in the polymerizable monomer used is preferred. A water-soluble polymerization initiator may also be used in combination with the oil-soluble initiator as needed. The polymerization initiator is used in a proportion of generally 0.1 to 20 parts by weight, preferably 0.3 to 15 parts by weight, more preferably 0.5 to 10 parts by weight per 100 parts by weight of the polymerizable monomer.

Upon the polymerization, it is preferable to use a molecular weight modifier. As examples of the molecular weight modifier, may be mentioned mercaptans such as t-dodecylmercaptan, n-dodecylmercaptan, n-octylmercaptan and 2,2,4,6,6-pentamethylheptane-4-thiol; and halogenated hydrocarbons such as carbon tetrachloride and carbon tetrabromide. The molecular weight modifier may be added before the initiation of the polymerization or in the middle of the polymerization. The molecular weight modifier is used in a proportion of generally 0.01 to 5 parts by weight, preferably 0.1 to 1 part by weight per 100 parts by weight of the polymerizable monomer.

Upon the preparation of the colored particles by the polymerization process, various kinds of additive components including the above-described charge control agent and parting agent may be used.

As a preferable preparation process of the colored particles, the polymerizable monomer, colorant and other additive components (parting agent, charge control agent, etc.) are uniformly mixed by means of a media type dispersing machine such as a ball mill to prepare a polymerizable monomer composition. After the polymerizable monomer composition is added to an aqueous dispersion medium containing the dispersion stabilizer, the resultant aqueous dispersion is stirred to form droplets of the polymerizable monomer composition in the aqueous dispersion medium. After the polymerization initiator is then added, a stirrer capable of rotating at a high speed is used to control a stirring rate and time so as to give colored particles having a desired particle diameter, thereby forming smaller droplets. The temperature of the aqueous dispersion medium upon the formation of the droplets is controlled within a range of generally 10 to 40° C., preferably 20 to 30° C.

While retaining such stirring that the droplets dispersed are precipitated, the aqueous dispersion is heated to a predetermined temperature to initiate polymerization. After the polymerization is continued for a fixed period of time, the reaction is stopped to obtain an aqueous dispersion of colored particles. Thereafter, an unreacted polymerizable monomer and volatile organic compounds that are by-products derived from the polymerization initiator, which cause a problem of odor upon fixing of a toner, are removed from the aqueous dispersion as needed. Acid washing is further conducted for the purpose of removing the dispersion stabilizer used upon the polymerization from the colored particles, and water washing and dehydration are further conducted repeatedly, and the resultant colored particles are dried, thereby collecting the colored particles.

The polymerization temperature of the polymerizable monomer composition is generally 40 to 100° C., preferably 50 to 95° C., more preferably 60 to 90° C. The polymerization time is generally 1 to 20 hours, preferably 2 to 10 hours. The drying temperature is generally 20 to 60° C., preferably 30 to 50° C.

In order to provide core-shell type colored particles by the polymerization process, a process comprising adding a polymerizable monomer for shell for forming a shell and a polymerization initiator in the presence of the colored particles formed by the suspension polymerization and further continuing the polymerization is preferred. As the polymerizable monomer for shell, a monomer capable of forming a polymer having a glass transition temperature of 80° C. or higher, such as styrene, acrylonitrile or methyl methacrylate, or a monomer mixture thereof is preferably used from the viewpoint of blocking resistance (storage stability, anti-aggregating property). The thickness of the shell layer is preferably at most 2 μm, more preferably at most 1 μm, particularly preferably at most 0.5 μm.

As the polymerization initiator for forming the shell, is preferably used a water-soluble polymerization initiator. As examples of the water-soluble polymerization initiator, may be mentioned persulfates such as potassium persulfate and ammonium persulfate; and azo type initiators such as 2,2′-azobis[2-methyl-N-(2-hydroxyethyl)propionamide] and 2,2′-azobis[2-methyl-N-[1,1-bis(hydroxymethyl)-2-hydroxyethyl]propionamide]. The water-soluble polymerization initiator is used in a proportion of generally 0.1 to 30 parts by weight, preferably 1 to 20 parts by weight per 100 parts by weight of the polymerizable monomer for shell.

In order to obtain a toner satisfying the requirements of the peak areas defined in the present invention by the polymerization process, the amount of the crosslinkable monomer used, the amount of the chain transfer agent used, the kind and amount of the polymerization initiator used and polymerization conditions such as a polymerization temperature are controlled. More specifically, as examples of the control, may be mentioned (1) to use, as the monovinyl monomer, a combination of an aromatic vinyl monomer and an acrylic ester monomer, (2) to control the proportion of the crosslinkable monomer used within a range of 0.1 to 0.5 part by weight per 100 parts by weight of the monovinyl monomer, (3) to use the monovinyl monomer in combination with the macromonomer, (4) to use the molecular weight modifier in a proportion of 0.1 to 1 part by weight per 100 parts by weight of the polymerizable monomer, (5) to use a charge control resin as the charge control agent, (6) to preset the polymerization temperature within a temperature range of preferably from 60° C. to 95° C., more preferably from 60° C. to 90° C., (7) to use a polyfunctional ester compound as the parting agent, and (8) to combine at least two of these conditions.

The toner according to the present invention can be produced by placing the above-described colored particles and external additive in a mixer such as a Henschel mixer and stirring them to apply the external additive to the surfaces of the colored particles, or embed a part thereof.

### EXAMPLES

The present invention will hereinafter be described more specifically by the following examples and comparative examples. However, the present invention is not limited to these examples alone. All designations of “part” or “parts” and “%” mean part or parts by weight and % by weight unless expressly noted.

Evaluation methods of various physical properties and properties or characteristics are as follows.

### 1. Properties of Colored Particles

### (1) Average Particle Diameter and Particle Diameter Distribution

The volume average particle diameter dv and particle diameter distribution, i.e., a ratio dv/dp of the volume average particle diameter dv to the number average particle diameter dp, of colored particles were measured by means of a Multisizer (manufactured by Beckmann Coulter Co.). The measurement by the Multisizer was conducted under conditions of an aperture diameter=100 μm, a medium=Isothone II, a concentration =10% and the number of particles measured=100,000 particles.

### (2) Average Circularity:

A container was charged with 10 ml of ion-exchanged water, 0.02 g of a surfactant (alkylbenzenesulfonic acid) as a dispersing agent was added thereto, and 0.02 g of a sample to be measured was further added to conduct a dispersing treatment for 3 minutes at 60 W by means of an ultrasonic dispersing machine. The concentration of the toner upon measurement was adjusted to 3,000 to 10,000 particles/μL to measure circularities as to 1,000 to 10,000 toner particles corresponding to circles having a diameter of 1 μm or greater by means of a Flow Particle Image Analyzer “FPIA-2100” manufactured by SYSMEX CORPORATION. An average circularity was found from the measured values.

### 2. Properties of Toner

### (1) Peak Area

A molecular weight was measured under the following conditions

1) After 0.1 g of a toner precisely weighed is placed in a 100-ml glass-made sample bottle, 49.9 g of THF is added.

2) A stirrer chip is placed to stir the toner for 1 hour at room temperature (23° C.) by means of a magnetic stirrer, thereby dissolving soluble components such as a binder resin to prepare a dispersion liquid.

3) The dispersion liquid is filtered through a polytetrafluoroethylene (PTFE)-made filter having a pore size of 0.2 μm to obtain THF-soluble matter A.

4) After a dispersion liquid obtained in the same manner as in the steps 1) and 2) is subjected to an ultrasonic treatment under conditions of output power of 20 W, a frequency of 20 kHz and 10 minutes, the dispersion liquid thus treated is filtered through a PTFE-made filter having a pore size of 0.2 μm to obtain THF-soluble matter B.

5) Each 100 μl of the THF-soluble matter A and THF-soluble matter B is poured into a GPC measuring device to conduct measurement. Each molecular weight was determined by converting a GPC solubility curve (chromatogram) thus obtained by means of a commercially available calibration curve by monodisperse standard polystyrene. In a molecular weight distribution obtained as the GPC solubility curve, a peak area of a molecular weight range of 500,000 to 5,000,000 and a peak area of a molecular weight range of 500 to 5,000 are calculated out, and percentages of these peak areas to the whole peak area of a molecular weight range of 500 to 5,000,000 in the GPC solubility curve are calculated out.

### <Measuring Conditions>

GPC: HLC-8220 (manufactured by TOSOH CORP.)
Column: TSK-GEL MULTIPORE HXL-M, 2 columns are directly linked (manufactured by TOSOH CORP.)
Eluate: THF
Flow rate: 1.0 ml/min
Temperature: 40° C.

The number average molecular weight (Mn), weight average molecular weight (Mw), peak molecular weight (Mp) and Mw/Mn of the binder resin (THF-soluble matter), which were obtained from the results of the GPC measurement, are shown in the following Table 1.

### (2) Content of Volatile Organic Compounds

The content of volatile organic compounds were measured under the following conditions.

1) After 3 g of a toner precisely weight was placed in a 100-ml screw glass bottle, 27 g of dimethylformamide was added, and the resultant mixture was stirred for 1 hour by means of a stirrer to dissolve the toner.

2) After 3 g of methanol was added to this solution, and stirring was successively conducted for 10 minutes to deposit a high-molecular component, the stirring was stopped to precipitate the deposit.

3) A supernatant was taken out by a syringe cylinder, and a filter (product of Advantech Co., Ltd., trade name “MEMBRANE FILTER 25JP020AN”) was fitted to the syringe cylinder to filter the supernatant, the resultant filtrate was subjected to measurement by means of a gas chromatograph.

4) Detection peaks other than dimethylformamide and methanol were regarded as volatile organic compounds to find a content (ppm) of volatile organic compounds per unit weight of the toner as a value in terms of styrene using a calibration curve prepared in advance.

### <Measuring Conditions>

Apparatus: GC-2010 (manufactured by Shimadzu Corporation)
Column: TC-WAX (manufactured by GL Sciences Inc.), df=0.5 μm, 0.25 mm I.D.×60 m
Detector: FID
Carrier gas: helium (linear velocity 21.3 cm/sec)
Inlet temperature: 200° C.
Detector temperature: 200° C.
Oven temperature: after held for 2 minutes at 100° C., the temperature was raised to 150° C. at a rate of 5° C./min, and held for 6 minutes at 150° C.
Sampling quantity: 2 μl.

### (3) Storage Stability

After a toner sample is placed in a closable container, and the container was closed, the container is sunk into a constant-temperature water bath controlled to 55° C. The container is taken out of the water bath after 8 hours have elapsed, and the toner contained in the container is transferred to a 42-mesh sieve so as not to destroy the structure of the toner. After the sieve was vibrated for 30 seconds by means of a powder-measuring device (manufactured by Hosokawa Micron Corporation, trade name “POWDER TESTER”) with a vibration width preset to 1.0 mm, the weight of the toner remaining on the sieve is measured to regard it as the weight of the toner aggregated. A percentage of the aggregated toner was calculated out from the weight of the aggregated toner and the weight of the toner sample to use a value thus obtained as an index to the storage stability of the toner. The smaller the numerical value, the higher the storage stability.

### 3. Properties of Toner (Evaluation of Image Quality)

### (1) Lowest Fixing Temperature

A commercially available printer (24 paper sheets per minute printer) of the non-magnetic one-component development system was modified in such a manner that the temperature of a fixing roll can be varied, and a fixing test was conducted by varying the temperature of the fixing roll at intervals of 5° C. to determine a fixing rate of a toner sample at each temperature, thereby finding a relationship between the temperature and the fixing rate.

The fixing rate was calculated in the following manner. At the time the temperature of the fixing roll was stabilized, solid printing was conducted on paper for printing by the modified printer. With respect to the solid-printed area of the printed paper, the fixing rate was calculated from a ratio of printing densities before and after a peeling operation using a tape. More specifically, assuming that the image density before the peeling of the tape is ID_{before}, and the image density after the peeling of the tape is ID_{after}, the fixing rate is calculated out in accordance with the following equation:

Fixing rate (%)=(ID_{after}/ID_{before})×100

The peeling operation of the tape is a series of operation that an adhesive tape (product of Sumitomo 3M Limited, trade name “SCOTCH MENDING TAPE 810-3-18”) is applied to a measuring area of paper for test to cause the tape to adhere to the paper by pressing the tape under a fixed pressure, and the adhesive tape is then peeled at a constant rate in a direction along the paper.

In this fixing test, the lowest temperature of temperatures of the fixing roll, at which the fixing rate of the toner amounted to 80% or higher, was defined as the lowest fixing temperature of the toner.

### (2) Hot Offset Temperature

The temperature of the fixing roll was varied at intervals of 5° C. in the same manner as in the measurement of the lowest fixing temperature to conduct black solid printing, thereby determine whether hot offset occurred or not. The lowest temperature of the fixing roll, at which hot offset occurred, was defined as a hot offset temperature of the toner.

### (3) Durability (Fog)

After the above-described printer was used and left to stand for a day under an environment of 23° C. in temperature and 50% in humidity, printing was continuously conducted on paper for printing at a printing density of 5%. Every 500 sheets of paper, white solid printing was conducted, the printing was stopped on the way, a toner present on a photosensitive member after development was stripped off by the above-described adhesive tape, and this adhesive tape was stuck on new paper for printing. A whiteness degree B of the paper for printing, on which this adhesive tape had been stuck, was measured by means of a whiteness meter (manufactured by Nippon Denshoku K.K.). A whiteness degree A of paper for printing, on which only an adhesive tape had been stuck, was measured. A difference between the whiteness degree A and the whiteness degree B was calculated out to regard the value as a fog value. The number of sheets of paper printed that could retain the fog value not higher than 1 was recorded. This test was conducted on 20,000 sheets of paper. “20,000<” in the following Table 1 indicates that the toner could retain the fog value not higher than 1 even when printing was continuously conducted on 20,000 sheets of paper.

### Example 1

A polymerizable monomer composed of 75 parts of styrene, 20 parts of n-butyl acrylate, 5 parts of cyclohexyl methacrylate, 0.2 part of divinylbenzene and 0.4 part of a polymethacrylic ester macromonomer (product of Toagosei Chemical Industry Co., Ltd., trade name “AA6”), 7 parts of carbon black (product of Mitsubishi Chemical Corporation, trade name “#25B”), 1 part of a charge control resin (product of Fujikura Kasei Co., Ltd., trade name “FCA-626-NS”; weight average molecular weight: 24,000, glass transition temperature: 60° C.), 10 parts of pentaerythritol tetramyristate, and 0.2 part of t-dodecylmercaptan were dispersed at room temperature (23° C.) by means of a bead mill to prepare a polymerizable monomer composition.

On the other hand, an aqueous solution with 5.8 parts of sodium hydroxide dissolved in 50 parts of ion-exchanged water was gradually added to an aqueous solution with 9.5 parts of magnesium chloride dissolved in 250 parts of ion-exchanged water with stirring at room temperature to prepare a dispersion liquid of colloid of magnesium hydroxide.

After the polymerizable monomer composition was poured into the dispersion liquid of the magnesium hydroxide colloid obtained above, stirring was conducted until droplets became stable, and 4 parts of 2,2′-azobis-(2,4-dimethylvaleronitrile) (product of Wako Pure Chemical Industries, Ltd., trade name “V-65”) wad added thereto, the resultant dispersion was treated for 30 minutes by means of a high-speed stirring machine, Ebara Milder (manufactured by Ebara Corporation, trade name “MDN303V”) rotating at 15,000 rpm to form droplets of the polymerizable monomer composition.

The dispersion liquid of the magnesium hydroxide colloid, in which the droplets of the polymerizable monomer composition had been formed, was placed in a reactor equipped with an agitating blade, and the dispersion liquid was heated under control in such a manner that the temperature of the dispersion liquid was fixed to 70° C., thereby initiating polymerization. After the polymerization was continued for 8 hours, the reaction was stopped to obtain an aqueous dispersion containing colored particles formed.

While stirring the above-obtained aqueous dispersion of the colored particles, sulfuric acid was added to adjust its pH to 6.5 or lower, thereby conducting acid washing. After water was separated by filtration, 500 parts of ion-exchanged water was newly added to form a slurry again, and the slurry was washed with water. Thereafter, dehydration and water washing were repeated several times, and solids were then separated by filtration. The solids were dried at 45° C. for 2 days by a dryer to obtain colored particles having a volume average particle diameter dv of 7.4 μm, a particle diameter distribution dv/dp of 1.19 and an average circularity of 0.979.

To 100 parts of the thus-obtained colored particles, were added, as an external additive, 1 part of silica (product of Nippon Aerosil Co., Ltd., trade name “RX100”), and the resultant mixture was mixed for 10 minutes at a rotating speed of 1,400 rpm by means of a Henschel mixer to obtain a toner. The properties of the resultant colored particles and toner and the results of the evaluation as to image quality are shown in Table 1.

### Example 2

Colored particles and a toner were obtained in the same manner as in Example 1 except that the amount of t-dodecylmercaptan was changed from 0.2 part in Example 1 to 0.4 part to prepare a polymerizable monomer composition. The properties of the resultant colored particles and toner and the results of the evaluation as to image quality are shown in Table 1.

### Example 3

Colored particles and a toner were obtained in the same manner as in Example 2 except that a polymerizable monomer composition was prepared without using pentaerythritol tetramyristate used in Example 2, and the amount of 2,2′-azobis(2,4-dimethylvaleronitrile) was changed from 4 parts to 6 parts. The properties of the resultant colored particles and toner and the results of the evaluation as to image quality are shown in Table 1.

### Comparative Example 1

A polymerizable monomer composed of 85 parts of styrene, 15 parts of n-butyl acrylate and 0.1 part of divinylbenzene, 7 parts of carbon black (product of Mitsubishi Chemical Corporation, trade name “#25B”), 1 part of a charge control agent (product of Orient Chemical Industries Ltd., trade name “BONTRON E-81”), and 15 parts of behenyl stearate were heated to 50° C., and uniformly dissolved or dispersed by means of a high-speed stirring machine, TK Homomixer (manufactured by Tokushu Kika Kogyo Co., Ltd.) at a rotating speed of 9,000 rpm. Four parts of 2,2′-azobis(2,4-dimethyl-valeronitrile) (product of Wako Pure Chemical Industries, Ltd., trade name “V-65”) was added to this dispersion to prepare a polymerizable monomer composition.

On the other hand, an aqueous solution with 5.8 parts of sodium hydroxide dissolved in 50 parts of ion-exchanged water was gradually added to an aqueous solution with 9.5 parts of magnesium chloride dissolved in 250 parts of ion-exchanged water with stirring at 50° C. to prepare a dispersion liquid of colloid of magnesium hydroxide.

The polymerizable monomer composition was poured into the dispersion liquid of the magnesium hydroxide colloid obtained above, and the resultant mixture was stirred at 9,500 ppm by means of the TK Homomixer under a nitrogen atmosphere at 55° C. to form droplets of the polymerizable monomer composition.

The dispersion liquid of the magnesium hydroxide colloid, in which the polymerizable monomer composition had been dispersed to form droplets, was placed in a reactor equipped with an agitating blade, and the dispersion liquid was heated under control in such a manner that the temperature of the dispersion liquid was fixed to 58° C. After the polymerization was continued for 8 hours, the reaction was stopped to obtain an aqueous dispersion of colored particles.

While stirring the above-obtained aqueous dispersion of the colored particles, sulfuric acid was added to adjust its pH to 6.5 or lower, thereby conducting acid washing. After water was separated by filtration, 500 parts of ion-exchanged water was newly added to form a slurry again, and the slurry was washed with water. Thereafter, dehydration and water washing were repeated several times, and solids were then separated by filtration. The solids were dried at 45° C. for 2 days by a dryer to obtain colored particles having a volume average particle diameter dv of 7.4 μm, a particle diameter distribution dv/dp of 1.23 and an average circularity of 0.979.

To 100 parts of the thus-obtained colored particles, were added, as an external additive, 1 part of silica (product of Nippon Aerosil Co., Ltd., trade name “RX100”), and the resultant mixture was mixed for 10 minutes at a rotating speed of 1,400 rpm by means of a Henschel mixer to obtain a toner. The properties of the resultant colored particles and toner and the results of the evaluation as to image quality are shown in Table 1.

### Comparative Example 2

Colored particles and a toner were obtained in the same manner as in Comparative Example 1 except that a polymerizable monomer obtained by changing the amount of divinylbenzene from 0.1 part in Comparative Example 1 to 0.3 part was used, and the polymerization initiator was changed from 4 parts of 2,2′-azobis(2,4-dimethylvaleronitrile) to 5 parts of t-butyl peroxy-2-ethylhexanoate (product of Nippon Oil & Fats Co., Ltd., trade name “PERBUTYL O”). The properties of the resultant colored particles and toner and the results of the evaluation as to image quality are shown in Table 1.

TABLE 1

| | Example | | | Comp. Example | |
|---|---|---|---|---|---|
| | 1 | 2 | 3 | 1 | 2 |
| Binder resin | | | | | |
| Number average molecular | 12,345 | 11,795 | 20,804 | 12,632 | 10,400 |
| weight Mn | | | | | |
| Weight average molecular | 202,152 | 136,658 | 144,759 | 179,511 | 133,521 |
| weight Mw | | | | | |
| Peak molecular weight Mp | 29,371 | 27,025 | 31,207 | 25,323 | 28,655 |
| Mw/Mn | 16.4 | 11.6 | 7.0 | 14.2 | 12.8 |
| Toner | | | | | |
| Volume average particle | 7.4 | 6.7 | 7.5 | 7.2 | 7.3 |
| diameter (μm) | | | | | |
| Particle diameter | 1.19 | 1.18 | 1.20 | 1.23 | 1.22 |
| distribution dv/dp | | | | | |
| Average circularity | 0.979 | 0.972 | 0.968 | 0.975 | 0.969 |
| Proportion of molecular | | | | | |
| weight-integrated value (%) | | | | | |
| Peak area a | 10.4 | 6.9 | 6.9 | 1.4 | 6.9 |
| Peak area b | 6.5 | 4.4 | 5.5 | 1.6 | 8.5 |
| Difference (a-b) | 3.9 | 2.5 | 1.4 | −0.2 | −1.6 |
| Peak area c | 7.3 | 7.5 | 3.8 | 10.3 | 11.2 |
| Content of volatile organic | 210 | 286 | 251 | 384 | 327 |
| compound (ppm) | | | | | |
| Properties of toner | | | | | |
| Storage stability (%) | 3.4 | 1.5 | 4.1 | 12.4 | 5.4 |
| Lowest fixing tarp. (° C.) | 160 | 145 | 165 | 160 | 185 |
| Hot offset temperature (° C.) | 210 | 200 | 200 | 185 | 215 |
| Durability (sheets) | 20,000< | 20,000< | 20,000< | 10,000 | 12,000 |

From the results shown in Table 1, the following facts are known.

The toner of Comparative Example 1, which is smaller in the peak area a, and the difference a−b between the peak area a and the peak area b than the respective ranges defined in the present invention, is poor in storage stability and durability and easy to cause hot offset.

The toner of Comparative Example 2, which is smaller in the difference a−b between the peak area a and the peak area b than the range defined in the present invention, is poor in low-temperature fixing ability and durability and easy to cause hot offset.

On the other hand, the toners (Examples 1 to 3), which satisfy the requirements of the proportion of the peak area a, the proportion of the peak area b and the difference a−b between the peak area a and the peak area b recited in the present invention, are low in the lowest fixing temperature, high in the hot offset temperature though fixing can be conducted at a low temperature, and hard to cause hot offset. It is also understood that the toners according to the present invention are good in storage stability, high in durability and low in the content of volatile organic compounds.

### INDUSTRIAL APPLICABILITY

According to the present invention, there can be provided toners for development of electrostatic images, which are excellent in hot offset resistance though they are excellent in low-temperature fixing ability, excellent in storage stability at a high temperature and also excellent in durability. The toners for development of electrostatic images according to the present invention can be used as developers in image forming methods and image forming apparatus of the electrophotographic system. The toners for development of electrostatic images according to the present invention are particularly suitable for use as developers used in a non-magnetic one-component development system.

1. A toner for development of electrostatic images, comprising colored particles containing at least a binder resin and a colorant, and an external additive, wherein
(a) the colored particles has a volume average particle diameter of 3 to 10 μm and an average circularity of 0.950 to 0.995,
(b) in a molecular weight distribution of the tetrahydrofuran-soluble matter A of the toner, which is obtained by filtering a dispersion liquid D1 prepared by adding 49.9 g of tetrahydrofuran to 0.1 g of the toner and stirring the resultant mixture for 1 hour at 23° C. through a filter having a pore size of 0.2 μm, by gel permeation chromatography (GPC) measurement, a peak area a of a molecular weight range of 500,000 to 5,000,000 in the whole molecular weight range of 500 to 5,000,000 is 5 to 15% based on the peak area of the whole range,
(c) in a molecular weight distribution of the tetrahydrofuran-soluble matter B of the toner, which is obtained by filtering a dispersion liquid D2 prepared by further subjecting the dispersion liquid D1 to an ultrasonic treatment for 10 minutes at output power of 20 W and a frequency of 20 kHz through a filter having a pore size of 0.2 μm, by GPC measurement, a peak area b of a molecular weight range of 500,000 to 5,000,000 in the whole molecular weight range of 500 to 5,000,000 is 1 to 10% based on the peak area of the whole range, and
(d) the peak area a and the peak area b satisfy the relationship of 0≦a−b≦5.

2. The developer for development of electrostatic images according to claim 1, wherein the peak area a is 7 to 10% based on the peak area of the whole range, and the peak area b is 3 to 7% based on the peak area of the whole range.

3. The developer for development of electrostatic images according to claim 1, wherein the peak area a and the peak area b satisfy the relationship of 1≦a−b≦5.

4. The developer for development of electrostatic images according to claim 1, wherein the peak area a and the peak area b satisfy the relationship of 1≦a−b≦4.

5. The developer for development of electrostatic images according to claim 1, wherein a peak area c of a molecular weight range of 500 to 5,000 by the GPC measurement of the tetrahydrofuran-soluble matter A of the toner is 3 to 20% based on the peak area of the whole range.

6. The developer for development of electrostatic images according to claim 1, wherein the peak area c of the molecular weight range of 500 to 5,000 by the GPC measurement of the tetrahydrofuran-soluble matter A of the toner is 5 to 15% based on the peak area of the whole range.

7. The developer for development of electrostatic images according to claim 1, wherein the content of volatile organic compounds is at most 500 ppm.

8. The developer for development of electrostatic images according to claim 1, wherein the content of volatile organic compounds is at most 300 ppm.

9. The developer for development of electrostatic images according to claim 1, wherein the colored particles contains a polyfunctional ester compound as a parting agent.

10. The developer for development of electrostatic images according to claim 9, wherein the polyfunctional ester compound is a polyfunctional ester compound whose endothermic peak temperature falls within a range of 30 to 150° C. upon heating thereof in a DSC curve determined by means of a differential scanning calorimeter (DSC).

11. The developer for development of electrostatic images according to claim 9, wherein the polyfunctional ester compound is a polyfunctional ester compound having a molecular weight of at least 1,000, a solubility of at least 5 parts by weight in 100 parts by weight of styrene at 25° C. and an acid value of at most 10 mg KOH/g.

12. The developer for development of electrostatic images according to claim 9, wherein the polyfunctional ester compound is pentaerythritol tetramyristate, pentaerythritol tetrapalmitate, dipentaerythritol hexamyristate or a mixture thereof.

13. The developer for development of electrostatic images according to claim 1, wherein the colored particles contain a charge control resin as a charge control agent.

14. The developer for development of electrostatic images according to claim 13, wherein the charge control resin is a quaternary ammonium (salt) group-containing copolymer or sulfonic (salt) group-containing copolymer.

15. The developer for development of electrostatic images according to claim 13, wherein the charge control resin has a weight average molecular weight of 6,000 to 30,000 and a glass transition temperature of 45 to 70° C.

16. The developer for development of electrostatic images according to claim 1, wherein the binder resin has a number average molecular weight (Mn) of 5,000 to 50,000, a weight average molecular weight (Mw) of 50,000 to 1,000,000 and a molecular weight distribution (Mw/Mn) of 3 to 30 as measured as values in terms of standard polystyrene by GPC.

17. The developer for development of electrostatic images according to claim 1, wherein the volume average particle diameter of the colored particles is 4 to 9 μm, and the particle diameter distribution dv/dp of the colored particles, which is represented by a ratio of the volume average particle diameter dv to the number average particle diameter dp, is 1.0 to 1.3.

18. The developer for development of electrostatic images according to claim 1, wherein the colored particles are obtained by a polymerization process.

19. The developer for development of electrostatic images according to claim 1, wherein the external additive is inorganic particles or organic particles, which are smaller in average particle diameter than the colored particles, or a mixture thereof, and its amount added is 0.5 to 3 parts by weight per 100 parts by weight of the colored particles.

20. The developer for development of electrostatic images according to claim 1, which is a non-magnetic one-component developer.
